(19) United States
(12) Patent Application Publication
(10) Pub. No.: US 2008/0227930 A1
(43) Pub. Date: Sep. 18, 2008

(54) Cross-Linkable Compositions Containing Allylorganopolysiloxanes

(75) Inventors: Hans Lautenschlager, Haiming (DE); Gilbert Geisberger, Altoetting (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/917,543

(22) PCT Filed: May 4, 2006
(86) PCT No.: PCT/EP2006/004200

§ 371 Date: Dec. 14, 2007

(30) Foreign Application Priority Data
Jun. 16, 2005 (DE) 10 2005 027 927.9

(51) Int. Cl. C08G 77/04; B05D 3/10

(52) U.S. Cl. 525/475; 525/478; 427/387

(57) ABSTRACT

Vinyl-terminated organopolysiloxanes also having pendant allyl functionality exhibit high cure rates with low extractables, while exhibiting superior release properties when compared to higher alkenyl functionality.

The invention relates to crosslinkable compositions comprising organopolysiloxanes containing alkenyl groups, organosilicon compounds containing Si-bonded hydrogen atoms, and catalysts, to shaped articles producible by crosslinking the compositions, and to a process for producing coatings.

As organopolysiloxanes containing alkenyl groups in crosslinkable compositions for producing surface coatings that repel tacky substances, more particularly for the coating of release paper, it is common to use linear diorganopolysiloxanes having terminal alkenyl groups, these siloxanes having pendant alkenyl groups, attached directly to D units, along the main chain. Crosslinkable compositions of this kind are described in U.S. Pat. No. 4,476,166 A, for example.

In EP 361477 A it is indicated that, if an alkenyl group having less than 4 carbon atoms is used, and if the resulting, copolymerized organopolysiloxane containing alkenyl groups is reacted in the presence of a platinum-containing substance, the reaction rate is unavoidably low.

In U.S. Pat. No. 4,609,574, diorganopolysiloxanes having pendant higher alkenyl groups, such as hexenyl groups, are obtained in a hydrosilylation reaction by reacting diorganopolysiloxanes having pendant SiH groups with α,ω-dienes, such as 1,5-hexadiene. This process, however, leads to the unwanted remanence of hexadiene in the polymer, which acquires an unwanted odor. The 1,5-hexadiene is relatively expensive as well. Furthermore, the 1,5-hexadiene readily undergoes isomerization to give hexenyl groups whose double bond is not terminal and which hence only crosslinks slowly.

In particular, however, the relatively large organic hexenyl groups increase the organic character of the diorganopolysiloxanes. This leads to improved adhesion on the part of the self-adhesive materials, and to poorer release force behavior of the release paper coating, particularly at high removal speeds.

The object was to provide crosslinkable compositions that comprise organopolysiloxanes containing alkenyl groups but which do not have the above disadvantages and which in particular, after crosslinking, necessitate a low release force at high removal speeds, without an attendant slowing of the crosslinking rate.

The invention provides crosslinkable compositions comprising
(A) organopolysiloxanes containing alkenyl groups, of the general formula (I)

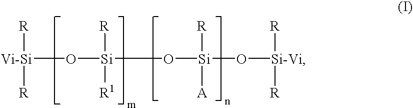

in which
R is a monovalent, SiC-bonded, unsubstituted or substituted hydrocarbon radical having 1 to 18 carbon atoms which is free from aliphatic carbon-carbon double bonds,
R¹ is a monovalent, SiC-bonded, unsubstituted or substituted hydrocarbon radical having 1 to 18 carbon atoms,
A is an allyl radical,
Vi is a vinyl radical,
m is a value from 40 to 1000, and
n is a value from 1 to 10,
(B) organosilicon compounds containing Si-bonded hydrogen atoms, and
(C) catalysts promoting the addition of Si-bonded hydrogen to aliphatic double bonds.

The crosslinkable compositions which comprise organopolysiloxanes (A) containing pendant allyl groups have the advantage that they exhibit high cure rates which are comparable with the cure rates of the compositions which comprise organopolysiloxanes (A) containing pendant hexenyl groups. At high cure rates of the compositions, in spite of short crosslinking times, low levels of extractables in the crosslinked compositions are found.

In the case of compositions comprising organopolysiloxanes (A) which in addition to pendant allyl groups also have terminal allyl groups, however, the cure rates are much slower.

In comparison to the larger pendant alkenyl groups, such as hexenyl groups, the allyl groups bring a smaller hydrocarbon fraction into the molecule. Consequently the silicone character is weakened to a lesser extent. After crosslinking, therefore, the crosslinkable compositions exhibit lower adhesion of self-adhesive materials, with the consequence that a lower release force is necessary at high removal speeds. Typical removal speeds are 200 to 400 m/min, more particularly 300 m/min.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical; cycloalkyl radicals, such as cyclopentyl, cyclohexyl, cycloheptyl, and methylcyclo-hexyl radicals; aryl radicals, such as the phenyl, naphthyl, anthryl and phenanthryl radical; alkaryl radicals, such as o-, m-, and p-tolyl radicals, xylyl radicals, and ethylphenyl radicals; and aralkyl radicals, such as the benzyl radical, the α- and the β-phenylethyl radical.

Examples of substituted radicals R are haloalkyl radicals, such as the 3,3,3-trifluoro-n-propyl radical, the 2,2,2,2′,2′,2′-hexafluoroisopropyl radical, the heptafluoroisopropyl radical, and haloaryl radicals, such as the o-, m-, and p-chlorophenyl radical.

The radical R is preferably a monovalent alkyl radical having 1 to 6 carbon atoms, the methyl radical being particularly preferred.

Examples of radicals R¹ are the examples and alkenyl radicals listed for the radical R, including those having a terminal aliphatic carbon-carbon double bond, such as the vinyl, 5-hexenyl, cyclohexenyl, 1-propenyl, allyl, 3-butenyl, and 4-pentenyl radical.

Preferably the radical R¹ has the definitions of R.

Preferably m has a value of 100 to 200, with particular preference 120 to 160. Preferably n has a value of 1 to 6, more particularly 2 to 5.

The organopolysiloxanes (A) preferably possess an average viscosity of 100 to 10 000 mPa·s at 25° C., more preferably 200 to 1000 mPa·s at 25° C.

The organopolysiloxanes (A) of the invention are prepared by customary processes, as for example by hydrolysis of allylmethyldichlorosilane with subsequent equilibration of the resulting hydrolyzate with cyclic polydimethylsiloxane and a vinyl-terminal dimethylsiloxane, using a suitable catalyst.

In the crosslinkable compositions use is made as organosilicon compounds (B), containing Si-bonded hydrogen atoms, preferably of linear, cyclic or branched organopolysiloxanes composed of units of the general formula (II)

R²ₐH_{b}SiO_{(4-a-b)/2} (II)

where
R² is a monovalent, SiC-bonded, unsubstituted or substituted hydrocarbon radical having 1 to 18 carbon atoms which is free from aliphatic carbon-carbon double bonds,
a is the value 0, 1, 2 or 3, and
b is the value 0, 1 or 2,
   and the sum of a+b is 0, 1, 2 or 3,
   with the proviso that there are on average at least 2 Si-bonded hydrogen atoms present per molecule.

Examples and preferred examples of hydrocarbon radicals R apply fully to hydrocarbon radicals R².

The organosilicon compounds (B) preferably contain at least 3 Si-bonded hydrogen atoms.

Preferred organosilicon compounds (B) are organopolysiloxanes of the general formula (III)

H_{c}R²_{3-c}SiO(SiR²₂O)_{d}(SiR²HO)ₑSiR²_{3-c}H_{c} (III)

where R² has the definition specified for it above,
c is the value 0, 1 or 2,
d is the value 0 or an integer from 1 to 1500, and
e is the value 0 or an integer from 1 to 200,
with the proviso that there are on average at least 2 Si-bonded hydrogen atoms present per molecule.

In the context of this invention the general formula (III) is to be understood in such a way that there can be d units —(SiR²₂O)— and e units —(SiR²HO)— distributed in any way in the organopolysiloxane molecule.

Examples of organopolysiloxanes of this kind are, in particular, copolymers composed of dimethylhydrosiloxane, methylhydrosiloxane, dimethylsiloxane, and trimethylsiloxane units, copolymers composed of trimethylsiloxane, dimethylhydrosiloxane, and methylhydrosiloxane units, copolymers composed of trimethylsiloxane, dimethylsiloxane, and methylhydrosiloxane units, copolymers composed of methylhydrosiloxane and trimethylsiloxane units, copolymers composed of methylhydrosiloxane, diphenylsiloxane, and trimethylsiloxane units, copolymers composed of methyhydrosiloxane, dimethylhydrosiloxane, and diphenylsiloxane units, copolymers composed of methylhydrosiloxane, phenylmethylsiloxane, trimethylsiloxane and/or dimethylhydrosiloxane units, copolymers composed of methylhydrosiloxane, dimethylsiloxane, diphenylsiloxane, trimethylsiloxane and/or dimethylhydrosiloxane units, and also copolymers composed of dimethylhydrosiloxane, trimethylsiloxane, phenylhydrosiloxane, dimethylsiloxane and/or phenylmethylsiloxane units.

The organopolysiloxanes (B) preferably possess an Si-bonded hydrogen atom content of 0.1% to 5% by weight, more particularly of 0.6% to 1.6% by weight.

The organopolysiloxanes (B) preferably possess an average viscosity of 10 to 1000 mPa·s, more particularly of 50 to 200 mPa·s at 25° C.

Organosilicon compound (B) is used preferably in amounts of 0.5 to 3.5, preferably 1.0 to 3.0 gram atom, of Si-bonded hydrogen per mole of hydrocarbon radical featuring terminal aliphatic carbon-carbon double bond in the organopolysiloxane (A).

For the crosslinkable compositions, as catalysts (C) promoting the addition of Si-bonded hydrogen to aliphatic double bonds, it is possible to use the same catalysts which it has also been possible to date to use to promote the addition of Si-bonded hydrogen to aliphatic double bond. Catalysts (C) used are preferably metals from the group of the platinum metals or compounds or complexes from the group of the platinum metals. Examples of such catalysts are metallic and finely divided platinum, which may be located on supports, such as silicon dioxide, aluminum oxide or activated carbon, compounds or complexes of platinum, such as platinum halides, e.g., PtCl₄, H₂PtCl₆*6H₂O, Na₂PtCl₄*4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆*6H₂O and cyclohexanone, platinum-vinylsiloxane complexes, such as platinum-1,3-divinyl-1,1,3,3-tetramethyldisiloxane complexes with or without detectable inorganically bonded halogen, bis(gamma-picoline)platinum dichloride, trimethylene-dipyridineplatinum dichloride, dicyclopentadieneplatinum dichloride, dimethyl sulfoxide-ethylene-platinum(II) dichloride, cyclooctadiene-platinum dichloride, norbornadiene-platinum dichloride, gamma-picoline-platinum dichloride, cyclopentadiene-platinum dichloride, and also reaction products of platinum tetrachloride with olefin and primary amine or secondary amine or primary and secondary amine, such as the reaction product of platinum tetrachloride in solution in 1-octene with sec-butylamine, or ammonium-platinum complexes.

The catalysts (C) are used preferably in amounts of 10 to 1000 ppm by weight (parts by weight per million parts by weight), preferably 20 to 200 ppm by weight, more particularly 50 to 100 ppm by weight, calculated in each case as elemental platinum metal and based on the total weight of the organosilicon compounds (A) and (B).

The crosslinkable compositions may comprise agents, known as inhibitors (D), which retard the addition of Si-bonded hydrogen to aliphatic multiple bond at room temperature.

For the crosslinkable silicone coating compositions as well it is possible as inhibitors (D) to use all the inhibitors which it has also been possible to use to date for the same purpose.

Examples of inhibitors (D) are 1,3-divinyl-1,1,3,3-tetramethyldisiloxane, benzotriazole, dialkylformamides, alkylthioureas, methyl ethyl ketoxime, organic or organosilicon compounds having a boiling point of at least 25° C. at 1012 mbar (abs.) and at least one aliphatic triple bond, such as 1-ethynylcyclohexan-1-ol, 2-methyl-3-butyn-2-ol, 3-methyl-1-pentyn-3-ol, 2,5-dimethyl-3-hexyne-2,5-diol, and 3,5-dimethyl-1-hexyn-3-ol, 3,7-dimethyloct-1-yn-6-en-3-ol, a mixture of diallyl maleate and vinyl acetate, maleic monoesters, and inhibitors such as the compound of the formula HC≡C—C(CH₃)(OH)—CH₂—H₂—CH═(CH₃)₂, available commercially under the trade name “Dehydrolinalool” from BASF.

Where inhibitor (D) is included, it is employed advantageously in amounts of preferably 0.01% to 10% by weight, more preferably 0.01% to 3% by weight, based on the total weight of the organosilicon compounds (A) and (B).

Examples of further constituents which can be included in the crosslinkable silicone coating composition are agents for adjusting the release force, antimisting additives, organic solvents, adhesion promoters, and pigments.

Examples of agents for adjusting the release force in the compositions are silicone resins constructed from units of the general formula (IV)

R³R⁴₂SiO_{1/2} (IV)

and SiO₂, referred to as MQ resins, where
R³ is a hydrogen atom or a monovalent, SiC-bonded, unsubstituted or substituted hydrocarbon radical having 1 to 18 carbon atoms and
R⁴ is a monovalent, SiC-bonded, unsubstituted or substituted hydrocarbon radical having 1 to 18 carbon atoms which is free from aliphatic carbon-carbon double bonds,
   and the units of the general formula (IV) can be identical or different.

The ratio of units of the general formula (IV) to units of the formula SiO₂ is preferably 0.6 to 2. The silicone resins are used preferably in amounts of 5% to 80% by weight, based on the total weight of the organosilicon compounds (A) and (B).

Examples and preferred examples of R³ are hydrocarbon radicals listed for R¹. Examples and preferred examples of R⁴ are hydrocarbon radicals listed for R.

Examples of antimisting additives are siloxane copolymers containing Si-bonded hydrogen atoms and preparable by reacting a compound (I) containing at least three aliphatic double bonds, of the general formula (V)

R⁵(CR⁶═CH₁)ₓ (V)

where
R⁵ is a trivalent or tetravalent hydrocarbon radical having preferably 1 to 25 carbon atoms per radical, which can contain one or more heteroatoms separate from one another and selected from the group of oxygen, silicon, and titanium,
R⁶ is a hydrogen atom or an alkyl radical having 1 to 6 carbon atoms per radical, and
x is value 3 or 4,
   with an organosiloxane (2) having terminal Si-bonded hydrogen atoms
   in the presence of catalyst (3) promoting the addition of Si-bonded hydrogen to aliphatic double bond,
   the ratio of Si-bonded hydrogen in the organosiloxane (2) to aliphatic double bond in organic compound (I) that is used being 1.3 to 10,
   and if desired, in a second step,
   equilibrating the resulting siloxane copolymers, containing Si-bonded hydrogen atoms, with organopolysiloxane (4),
   selected from the group consisting of linear organopolysiloxanes containing terminal triorganosiloxy groups, linear organopolysiloxanes containing terminal hydroxyl groups, branched organopolysiloxanes optionally containing hydroxyl groups, cyclic organopolysiloxanes, and copolymers composed of diorganosiloxane units and monoorganosiloxane units, being employed.

Further examples of antimisting additives are siloxane copolymers containing alkenyl groups and comprising
(a) siloxane units of the general formula (VI)

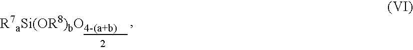

where
R⁷ is unhalogenated or halogenated hydrocarbon radicals having 1 to 18 carbon atoms per radical,
R⁸ is alkyl radicals having 1 to 4 carbon atoms per radical, which may be substituted by an ether oxygen atom,
a is value 0, 1, 2 or 3, and
b is value 0, 1, 2 or 3, and the sum a+b is not greater than 3,
(b per molecule at least one siloxane unit of the general formula (VII)

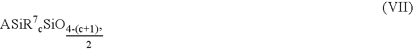

where
R⁷ has the definition specified for it above,
c is value 0, 1 or 2,
A is a radical of the general formula (VIII)

—CH₂CHR¹⁰—R⁹(CR¹⁰═CH₂)_{y-1} (VIII)

where
R⁹ is a divalent, trivalent or tetravalent hydrocarbon radical having 1 to 25 carbon atoms per radical,
R¹⁰ is a hydrogen atom or an alkyl radical having 1 to 6 carbon atoms per radical, and
y is value 2, 3 or 4, and
(c) on average per molecule at least one unit selected from the group of units of the general formula (IX) to (XI)

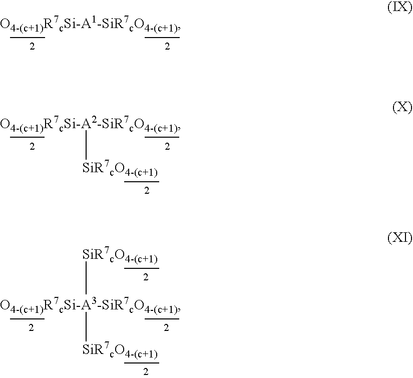

where R⁷ and c have the definition specified for them above,
A¹ is a radical of the general formula (XII)

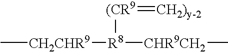

where R⁸, R⁹, and y have the definition specified above for them,
A² is a radical of the general formula (XIII)

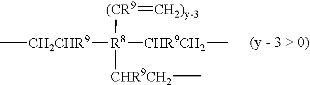

where
R⁸, R⁹ and y have the definition specified above for them, with the proviso that R⁸ is not a divalent hydrocarbon radical, and
A³ is a radical of the general formula (XIV)

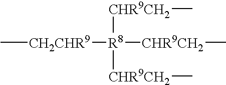

where R⁸ and R⁹ have the definition specified above for them, with the proviso that R⁸ is not a divalent or trivalent hydrocarbon radical.

Examples of suitable organic solvents are benzines, e.g. alkane mixtures having a boiling range of 70° C. to 180° C., n-heptane, benzene, toluene, and xylenes, halogenated alkanes having 1 to 6 carbon atom(s), such as methylene chloride, trichloroethylene, and perchloroethylene, ethers, such as di-n-butyl ether, esters, such as ethyl acetate, and ketones, such as methyl ethyl ketone and cyclohexanone.

Where organic solvents are included, they are used advantageously in amounts of preferably 10% to 90% by weight, more preferably 10% to 70% by weight, based on the total weight of the organosilicon compounds (A) and (B).

Although the sequence when mixing constituents (A), (B), (C), and, where appropriate, (D) is not critical, it has nevertheless been found appropriate in practice to add constituent (C), viz. the catalyst, last to the mixture of the other constituents.

The compositions of the invention are crosslinked preferably at 70° C. to 180° C. Energy sources used for crosslinking by heating are preferably ovens, examples being forced-air drying cabinets, heating tunnels, heated rollers, heated plates, or infrared thermal radiation.

Apart from by heating, the compositions of the invention can also be crosslinked by irradiation with ultraviolet light or by irradiation with UV and IR light. Ultraviolet light used is usually that having a wavelength of 253.7 nm. On the market there are a large number of lamps which emit ultraviolet light having a wavelength of 200 to 400 nm and which preferentially emit ultraviolet light having a wavelength of 253.7 nm.

The invention further provides shaped articles producible by crosslinking of the compositions of the invention.

The shaped articles preferably comprise coatings, more preferably surface coatings that repel tacky substances.

The invention further provides a process for producing coatings by applying crosslinkable compositions of the invention to the surfaces that are to be coated and then crosslinking the compositions.

The crosslinkable compositions of the invention are used preferably for producing surface coatings that repel tacky substances, such as for producing release papers, for example. Surface coatings that repel tacky substances are produced by applying crosslinkable compositions of the invention to the surfaces that are to be made repellent to tacky substances, and then crosslinking the compositions.

The application of the compositions of the invention to the surfaces to be coated, preferably surfaces to be made repellent to tacky substances, may be accomplished in any desired manner which is suitable and widely known for the production of coatings from liquid materials: for example, by dipping, brushing, pouring, spraying, rolling, printing, by means of an offset gravure coating apparatus, for example, by blade or knife coating, or by means of an air brush.

The coat thickness on the surfaces to be coated is preferably 0.3 to 6 μm, with particular preference 0.5 to 2.0 μm.

The surfaces to be coated, preferably surfaces to be made repellent to tacky substances, that may be treated in the context of the invention may be surfaces of any materials which are solid at room temperature and 1012 mbar (abs.). Examples of surfaces of this kind are those of paper, wood, cork, and polymer films, e.g., polyethylene films, polyester films or polypropylene films, woven and non-woven fabric of natural or synthetic fibers, ceramic articles, glass, including glass fibers, metals, polyethylene-coated paper, and boards, including those of asbestos. The above-mentioned polyethylene may in each case be high-pressure, medium-pressure or low-pressure polyethylene. In the case of paper the paper in question may be of a low-grade kind, such as absorbent papers, including kraft paper which is in the raw state, i.e., has not been treated with chemicals and/or natural polymeric substances, and which has a weight of 60 to 150 g/m², unsized papers, papers of low freeness value, mechanical papers, unglazed or uncalendered papers, papers which are smooth on one side owing to the use of the dry glazing cylinder during their production, without additional complex measures, and which are therefore referred to as “machine-glazed papers”, uncoated papers or papers produced from waste paper, i.e., what are known as recycled papers. The paper to be treated in accordance with the invention may also of course, however, comprise high-grade paper types, such as low-absorbency papers, sized papers, papers of high freeness value, chemical papers, calendered or glazed papers, glassine papers, parchmentized papers or precoated papers. The boards as well may be of high or low grade.

The compositions of the invention are suitable, for example, for producing release, backing, and interleaving papers, including interleaving papers which are employed in the production of, for example, cast films or decorative films, or of foam materials, including those of polyurethane. The compositions of the invention are additionally suitable, for example, for producing release, backing, and interleaving cards, films, and cloths, for treating the reverse faces of self-adhesive tapes or self-adhesive sheets, or the written faces of self-adhesive labels. The compositions of the invention are additionally suitable for treating packing material, such as that comprising paper, cardboard boxes, metal foils, and drums, e.g., cardboard, plastic, wood or iron, which is intended for storing and/or transporting tacky goods, such as adhesives, sticky foodstuffs, e.g., cakes, honey, candies, and meat; bitumen, asphalt, greased materials, and crude rubber. A further example of the application of the compositions of the invention is the treatment of carriers for transferring pressure-sensitive adhesive layers in the context of what is known as the transfer process.

The compositions of the invention are suitable for producing the self-adhesive materials joined to the release paper, both by the off-line method and by the in-line method.

In the off-line method, the silicone composition is applied to the paper and crosslinked, and then, in a subsequent stage, not only after the winding of the release paper onto a roll and after the storage of the roll, an adhesive film, present for example on a label face paper, is applied to the coated paper and the composite is then compressed. In the in-line method the silicone composition is applied to the paper and crosslinked, the surface silicone coating is coated with the adhesive, the label face paper is then applied to the adhesive, and the composite, finally, is compressed.

In the case of the off-line method the winding speed is governed by the time needed to render the surface silicone coating tack-free. In the case of the in-line method the process speed is governed by the time needed to render the surface silicone coating migration-free.

All of the above symbols in the above formulae have their definitions in each case independently of one another.

In the application examples which follow, all references to parts and percentages are by weight. The examples were carried out under the pressure of the surrounding atmosphere, in other words at 1012 mbar approximately, and at room temperature, in other words at 21° C. approximately. The viscosities were measured at 25° C.

### EXAMPLES

The allylorganopolysiloxane polymer A used in accordance with the invention was compared in crosslinkable compositions with pendant-vinyl polymer B, pendant-hexenyl polymer C, and pendant-vinyl polymer D.

Polymer A: Vi(CH₃)₂Si(OSi(CH₃)₂)₁₄₀(OSi(CH₃)A)₂OSi(CH₃)₂Vi

Polymer B: Vi(CH₃)₂Si(OSi(CH₃)₂)₁₄₀(OSi(CH₃)Vi)₂OSi(CH₃)₂Vi

Polymer C: Vi(CH₃)₂Si(OSi(CH₃)₂)₁₄₀(OSi(CH₃)Hex)₂OSi(CH₃)₂Vi

Polymer D: Vi(CH₃)₂Si(OSi(CH₃)₂)₁₄₀₀Si(CH₃)₂Vi

Hex denotes hexenyl radical and Vi and A have the above definitions.

The standard formulation used was a mixture of

100 parts by weight each of polymers A to D,
8 parts by weight of a linear polysiloxane composed of hydromethylsiloxane and dimethylsiloxane units in a molar ratio of 3:1 with terminal trimethylsiloxane units and a viscosity of 34 mPa·s (25° C.),
1.1 parts by weight of a 1% by weight (based on elemental platinum) solution of a platinum-1,3-divinyl-1,1,3,3-tetramethyldisiloxane complex in an α,ω-divinyldimethylpolysiloxane having a viscosity of 1000 mPa·s at 25° C., and
0.3 part by weight of 1-ethynylcyclohexanol.

These mixtures were used for paper coating.

The substrate used was paper from Ahlstrom bearing the designation Glassine Silca Classic. Coating took place on a Dixon coating unit of model number 1060 with a 5-roll applicator mechanism, at 90 m/min. The coating was cured at 140° C. in a drying oven 3 m long. This corresponds to a crosslinking time of 2 seconds.

The coating weight was determined by means of X-ray fluorescence analysis in reference to an appropriate standard. The curing of the coating system was determined by extracting non-crosslinked fractions in MIBK (methyl isobutyl ketone) and determining the extracted silicon content by atomic absorption spectrometry.

In an experiment the coated papers were laminated with a hotmelt-adhesive-based label material common in the label industry. Prior to the determination of the release value, in accordance with FINAT test method FTM 10, the laminates were stored for 4 days at 25° C. under a pressure of 70 g/m².

In a further test, the coated papers were laminated with an aqueous-acrylate-adhesive-based label material common in the label industry. Prior to the determination of the release value, in accordance with FINAT test method FTM 3, the laminates were stored at 50° C. for 20 hours under a pressure 70 g/m².

The release values of the laminates produced in this way were determined in accordance with FINAT test method FTM 10 with removal speeds of 0.3 m/min, 10 m/min, and 300 m/min.

The test methods are described in the DEHESIVE® Silicones Test Methods brochure from Wacker-Chemie GmbH and in the FINAT Technical Handbook (test methods) 6th edition.

The results are summarized in table 1.

TABLE 1

| | | Release values | | | Release values | | |
|---|---|---|---|---|---|---|---|
| | | Hot-melt adhesive | | | Acrylate adhesive | | |
| | | laminate | | | laminate | | |
| Polymer | Extract % | 0.3 m/min | 10 m/min | 300 m/min | 0.3 m/min | 10 m/min | 300 m/min |
| A | 2.6 | 6.8 | 4.0 | 10.4 | 7.1 | 4.3 | 12.7 |
| B | 12.3 | 3.8 | 3.3 | 12.0 | 4.9 | 4.0 | 17.5 |
| C | 2.8 | 4.6 | 4.9 | 12.3 | 5.8 | 5.5 | 13.0 |
| D | 10.6 | 2.6 | 3.8 | 18.5 | 2.4 | 4.0 | 24.4 |

The results show very low extract values for the crosslinkable silicone composition of the invention based on polymer A, which corresponds to a very rapid cure rate.

The release values at 300 m/min are low in comparison to the comparative polymers. This is advantageous for the further processing of the label laminate.

1.-8. (canceled)

9. A crosslinkable composition comprising
(A) organopolysiloxanes containing alkenyl groups, of the formula (I) 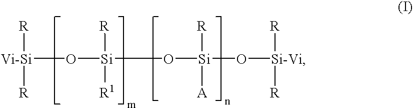
wherein
R is a monovalent, SiC-bonded, unsubstituted or substituted hydrocarbon radical having 1 to 18 carbon atoms which is free from aliphatic carbon-carbon double bonds,
R¹ is a monovalent, SiC-bonded, unsubstituted or substituted hydrocarbon radical having 1 to 18 carbon atoms,
A is an allyl radical,
Vi is a vinyl radical,
m is from 40 to 1000, and
n is from 1 to 10,
(B) organosilicon compound(s) containing Si-bonded hydrogen atoms, and
(c) at least one catalyst which promotes the addition of Si-bonded hydrogen to aliphatic double bonds.

10. The crosslinkable composition of claim 9, wherein the radical R is a methyl radical.

11. The crosslinkable composition of claim 9, wherein organosilicon compounds (B) comprise linear, cyclic or branched organopolysiloxanes comprising units of the formula (II)
R²ₐH_{b}SiO_{(4-a-b)/2} (II)
where
R² is a monovalent, SiC-bonded, unsubstituted or substituted hydrocarbon radical having 1 to 18 carbon atoms which is free from aliphatic carbon-carbon double bonds,
a is 0, 1, 2 or 3, and
b is 0, 1 or 2,
and the sum of a+b is 0, 1, 2 or 3,
with the proviso that there are on average at least 2 Si-bonded hydrogen atoms present per molecule.

12. The crosslinkable composition of claim 10, wherein organosilicon compounds (B) comprise linear, cyclic or branched organopolysiloxanes comprising units of the formula (II)
R²ₐH_{b}SiO_{(4-a-b)/2} (II)
where
R² is a monovalent, SiC-bonded, unsubstituted or substituted hydrocarbon radical having 1 to 18 carbon atoms which is free from aliphatic carbon-carbon double bonds,
a is 0, 1, 2 or 3, and
b is 0, 1 or 2,
and the sum of a+b is 0, 1, 2 or 3,
with the proviso that there are on average at least 2 Si-bonded hydrogen atoms present per molecule.

13. The crosslinkable composition of claim 9, wherein at least one catalyst (C) comprises a platinum group metal or a compound or complex of a platinum group metal.

14. The crosslinkable composition of claim 10, wherein at least one catalyst (C) comprises a platinum group metal or a compound or complex of a platinum group metal.

15. The crosslinkable composition of claim 11, wherein at least one catalyst (C) comprises a platinum group metal or a compound or complex of a platinum group metal.

16. A shaped article prepared by crosslinking a composition of claim 9.

17. The shaped article of claim 16, which is a coating.

18. The shaped article of claim 16, which is a surface coating that repels tacky substances.

19. A process for producing a coating, comprising applying a crosslinkable composition of claim 9 to a surface to be coated, and crosslinking the composition.
